(19) United States
(12) Patent Application Publication
(10) Pub. No.: US 2003/0096086 A1
(43) Pub. Date: May 22, 2003

(54) Touch panel and method of manufacturing the same

(76) Inventors: Kenichi Matsumoto, Osaka (JP); Koji Tanabe, Osaka (JP); Toshiharu Fukui, Nara (JP); Kenichi Takabatake, Osaka (JP); Kenji Niho, Osaka (JP)

Correspondence Address: RATNERPRESTIA, P O BOX 980, VALLEY FORGE, PA, 19482-0980, US

(21) Appl. No.: 10/283,509

(22) Filed: Oct. 30, 2002

(30) Foreign Application Priority Data
Nov. 2, 2001 (JP) 2001-337668

(51) Int. Cl. C09K 19/00; B32B 23/02

(52) U.S. Cl. 428/194; 428/1.5

(57) ABSTRACT

An inexpensive touch panel securing a predetermined active area and yet being downsized is provided. The touch panel includes an upper substrate having an upper conductive layer beneath its lower face, and a lower substrate having a lower conductive layer on its upper face opposite to the upper conductive layer at a given interval. Pressing and heating a adhesive layer made from thermoplastic resin and hardener allows bonding the upper and lower substrates together. The touch panel is thus constructed.

### FIELD OF THE INVENTION

The present invention relates to touch panels used for operating various electronic apparatuses, and it also relates to a method of manufacturing the same touch panel.

BACKGROUND OF THE INVENTION

Electronic apparatuses have been recently sophisticated and diversified. In the circumstances, a number of the apparatuses that are equipped with a transparent touch panel (hereinafter referred to TTP) on a front face of a display device such as a liquid crystal display device has increased. Through this TTP, a user not only recognizes or selects letters, symbols, or patterns displayed on the display device, but also switches a function to another one of the apparatus. Japanese Patent Application Non-examined Publication No. H04-123728 discloses such a conventional TTP.

FIG. 4 shows a sectional view of a conventional TTP, which comprises insulating substrate 10 (e.g. polyester film) having upper electrode 20 and another insulating substrate 30 (e.g. glass plate) having lower electrode 40. Substrate 10 is laminated on substrate 30 via spacer 50. Plural strips of upper electrodes 20 are prepared in parallel, and dot spacers 70 are disposed on surface of substrate 30. Spacers 50 are made from material hard to be plastically deformed such as rubber sheet, urethane, or urethane foam. Spacer 50 are bonded to the ends of substrate 10 and substrate 30 with adhesive 60.

In the foregoing structure, upper electrodes 20 and lower electrodes 40 are coupled with a detecting circuit of an electronic apparatus. An active area for both of depressing and detecting a position excludes the portions of spacers 50 and adhesive layers 60 between the lower face of upper substrate 10 and spacers 50 from the total area of upper substrate 10. Depressing this active area with a pen or a finger detects a position through the following mechanism: Upper substrate 10 bows, and upper electrode 20 at the depressed spot is brought into contact with lower electrode 40. The depressed spot is detected with a resistance ratio of electrode 20 vs. electrode 40. Widths of spacer 50 and adhesive layer 60 can be somewhat narrow to get a given adhesion strength. However, too narrow widths make the works difficult such as cutting or bonding, thus the widths of 2.5-3.0 mm are mainly employed. Since the structure includes the adhesive layer and the spacers, numbers of elements and manufacturing steps increase, which eventually boosts the cost.

In a case of printing adhesive layer 60 on either one of upper substrate 10 or lower substrate 30 in stead of providing spacer 50 and adhesive layer 60, the narrower width can work; however, the width of 2.5-3.0 mm is still necessary for obtaining the given adhesion strength. In both of the cases, the adhesive layer is made from thermoplastic resin that is tacky at room temperature. Thus the given adhesion strength can be obtained with a predetermined width. However, if the TTP is used at high temperatures, the adhesion strength lowers. In other words, heat-resistance holding power lowers. Therefore, the adhesive layer has a width of greater than 2.5 mm in general from a practical point of view. As discussed above, adhesive layer 60 and spacer 50 of the conventional TTP need a width of greater than 2.5 mm respectively, which eventually reduces the active area to be used for depressing and detecting a position. A predetermined active area is, therefore, obliged to be larger than an actual active area by the width of spacer 50 or adhesive layer 60. As a result, an outer dimension of the TTP becomes large, and it is difficult to downsize it. The conventional TTP thus has problems of downsizing and cost reduction.

### SUMMARY OF THE INVENTION

The present invention aims to provide a touch panel comprising the following elements:

an upper substrate having an upper conductive layer at its lower face;

a lower substrate having a lower conductive layer at its upper face; and

a adhesive layer disposed between the upper and lower substrates for bonding both the substrates together at given spots, and made of thermoplastic resin and isocyanate hardener, and having a width ranging from 0.5 to 2.5 mm.

### BRIEF DESCRIPTION OF THE DRAWINGS

FIG. 1 is a sectional view of a TTP in accordance with an exemplary embodiment of the present invention.

FIG. 2 is a plan view of a TTP in accordance with the exemplary embodiment of the present invention.

FIG. 3 is a plan view of a TTP in accordance with another exemplary embodiment of the present invention.

FIG. 4 is a sectional view of a conventional TTP.

### DETAILED DESCRIPTION OF EXEMPLARY EMBODIMENT

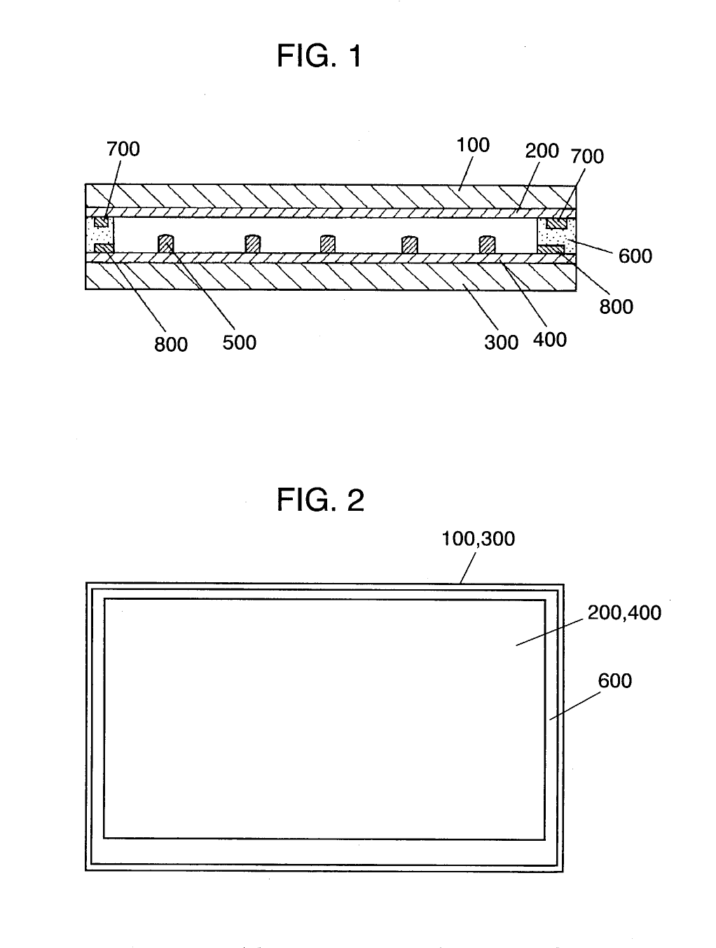

An exemplary embodiment of the present invention is demonstrated hereinafter with reference to FIG. 1 through FIG. 3. The drawings are schematic ones and do not show exact dimensional positions.

Exemplary Embodiment

FIG. 1 is a sectional view of a TTP in accordance with this exemplary embodiment of the present invention. Transparent upper conductive layer 200 is formed beneath a lower face of transparent upper substrate 100, which is made from transparent film such as polyethylene terephthalate or polycarbonate. Upper conductive layer 200 is made by vapor-depositing or sputtering transparent conductive material such as indium tin oxide or tin oxide. A pair of upper electrodes 700 are formed by printing conductive paste such as silver or carbon on both ends of upper conductive layer 200.

Lower substrate 300 is made from glass, acrylic resin, or polycarbonate resin, and transparent lower conductive layer 400 is formed on upper face of lower substrate 300. On upper face of lower conductive layer 400, a pair of lower electrodes 800 are prepared on both ends of layer 400 in a direction orthogonal to electrodes 700. Plural dot spacers 500 are formed at intervals of a given distance so that lower layer 400 and upper layer 200 can be kept apart at a predetermined interval. Dot spacers 500 are made of insulating material such as epoxy resin or silicone resin. Adhesive layer 600 is made from adhesive which produces adhesion by heating plus pressing or only pressing. This adhesive is made of thermoplastic resin to which isocyanate hardener is added in an amount of 100:5 in weight. Adhesive layer 600 is formed such that at least one of the lower face of upper substrate 100 or the upper face of lower substrate 300 is bordered like a frame with adhesive layer 600. A thickness of layer 600 ranges from 5 μm to 50 μm, and its modulus of elasticity ranges at room temperature from 10⁴ to 10⁹ Pa.

Adhesive layer 600 bonds the outer walls of upper substrate 100 and lower substrate 300 so that upper conductive layer 200 and lower conductive layer 400 face each other at a predetermined interval.

The TTP formed of the adhesive that produces adhesion by heating and pressing is taken as an example in FIG. 2 which further details this TTP. Adhesive layer 600 is printed by screen printing at a given place like a frame on lower substrate 300 having lower conducive layer 400. Frame-like adhesive layer 600 has a width ranging from 0.5 to 2.5 mm. Next, upper substrate 100 having upper conductive layer 200 is placed above layer 400 at a predetermined interval. Then adhesive layer is heated and pressed to cure. Substrate 100 and substrate 300 are thus bonded together, so that a TTP is produced.

At this time, acrylic resin or polyester resin contained in adhesive layer 600 reacts with isocyanate hardener by heating at a temperature of 60-100° C. and pressing. This reaction produces urethane bond having large amount of cohesive energy. The thermoplastic resin to be used in the present invention can be any resin that includes active hydrogen reactive with isocyanate hardener. Resin includes hydroxyl group or amino group can be one of those resins. It is preferable to use acrylic resin or polyester resin, more preferably, they have a greater average molecular weight. Among the polyol having the hydroxyl group reactive with the isocyanate hardener, acrylic polyol or polyester polyol has a greater average molecular weight, and they have more reactive groups than other urethane polyol, so that these two kinds of polyol can increase cross-linking density. As a result, holding power at high temperatures can be increased in addition to the adhesion strength at room temperature. It is more preferable that a use of the thermoplastic resin, of which average molecular weight is not less than 2×10⁵, can eliminate heating from the step of heating and pressing. In other words, the average molecular weight of not less than 2×10⁵ can produce high cohesive energy in the resin per se, so that adherence obtained by only pressing can easily produce the holding power at high temperatures. The isocyanate hardener preferably includes plural isocyanate groups in one molecule.

Upper substrate 100 and lower substrate 300 are thus bonded together tightly and hard to come off from each other even in hot and humid environment. The TTP thus produced is coupled with a detecting circuit of an electronic apparatus at its upper electrode 700 and lower electrode 800.

An area excluding the place of adhesive layer 600 from the total area of upper substrate 600 , namely, an active area for depressing and detecting a position, is depressed with a pen or a finger, then this position is detected in the following mechanism: Upper substrate 100 bows, and upper conductive layer 200 at the depressed spot is brought into contact with lower conductive layer 400. The depressed spot is detected with a resistance ratio of upper electrode 700 vs. lower electrode 800.

As discussed above, this embodiment proves that a use of adhesive layer 600 comprising thermoplastic resin and isocyanate hardener can increase cross-linking density in the resin of layer 600 by heating and pressing the adhesive layer. As a result, holding power at high temperatures can be increased in addition to the adhesion strength at room temperature, so that the width of the adhesive layer can be narrowed to 0.5-2.5 mm. When an average molecular weight of the thermoplastic resin is not less than 2×10⁵, the advantage discussed above can be obtained by only pressing. The TTP can be downsized securing its predetermined active area, and the method of manufacturing the TTP can be thus obtained.

Printing the adhesive layer 600 on at least one of upper substrate 100 or lower substrate 300 can eliminate a member such as a spacer, to whose both upper and lower faces adhesive layer 600 have been applied. As a result, the number of elements is reduced, which lowers the cost.

A thickness of adhesive layer 600 ranges from 5 to 50 μm, this thickness allows spacing the upper and lower conductive layers at an enough interval. Further, a depression at the vicinity of adhesive layer 600 applies less bending stress to upper conductive layer 200 than in a case of a thicker layer 600. Thus upper conductive layer 200 is prevented from breakage.

The reason why the modulus of elasticity of adhesive layer 600 at room temperature is set in the range from 10⁴ to 10⁹ Pa is this: If the coefficient is less than 10⁴ Pa, layer 600 becomes soft and cannot produce enough bonding strength, so that the upper substrate and lower substrate tend to come off from each other. If the coefficient is greater than 10⁹ Pa, layer 600 becomes hard, so that it is hard for the upper substrate and lower substrate to be bonded together. An additive amount of the isocyanate hardener to adhesive layer 600 is preferably 1-10 in weight vs. the thermoplastic resin in weight of 100.

If this hardener is less than 1 in weight, holding power at high temperatures lowers, so that upper substrate 100 and lower substrate 300 tend to come off at high temperatures from each other. If the hardener is more than 10 in weight, the curing reaction is accelerated even at room temperature and the adhesive layer hardens, so that it is hard for upper substrate 100 and lower substrate 300 to be bonded together. The additive amount of the hardener within the above range can bond upper substrate 100 and lower substrate 300 together strong enough not to come off from each other at high temperatures and, not to mention, at room temperature.

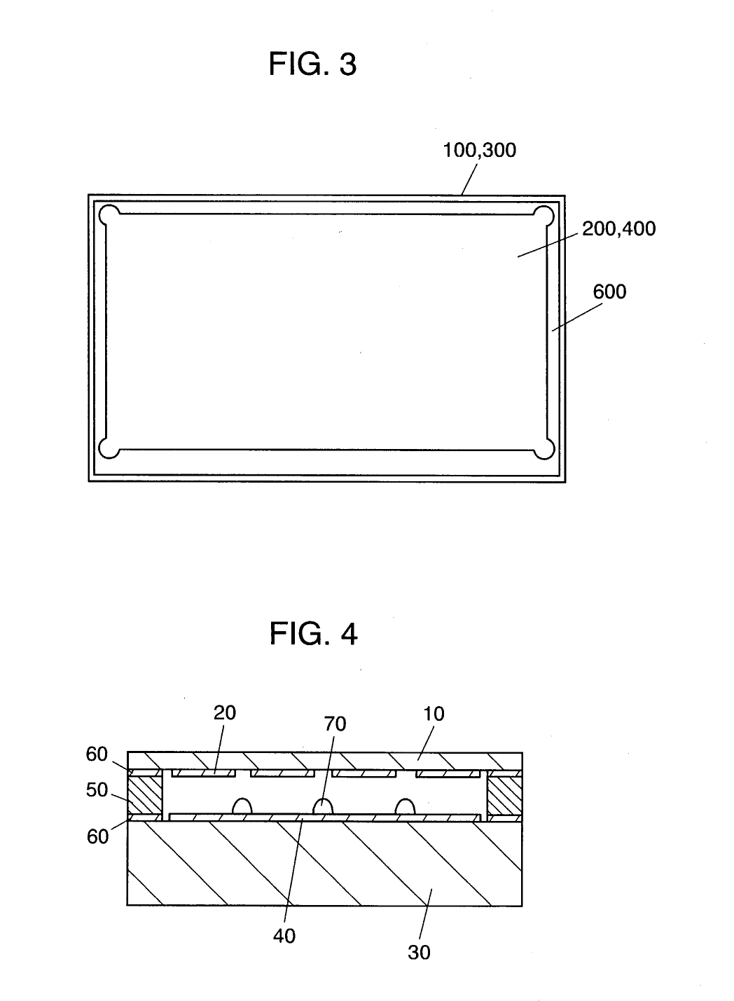

Further as shown in FIG. 3, notches are prepared at the corners of frame-like adhesive layer 600, so that the corners become narrower than the other portions. This structure can prevent adhesive layer 600 from draining or bulging out, in other words, it can prevent the active area from decreasing.

In the foregoing descriptions adhesive layer 600 made from thermoplastic resin such as acrylic resin or polyester resin is used; however, other materials, e.g., thermoplastic resin, such as epoxy, of which property is modified with acrylic resin or polyester resin can be used.

In this embodiment, the upper and lower substrates are bonded with adhesive layer 600 free from other members such as spacers; however, the adhesive of the present invention can be applied to the following case in manufacturing TTPs. Adhesive layer 600 is applied to both faces of a member such as non-woven fabric or polyester film.

The present invention can be applied to a case where upper substrate 100, lower substrate 300, upper conductive layer 200, or lower conductive layer 400 is not transparent. Lower substrate 300 can be formed of transparent film as same as the upper substrate 100.

The present invention can thus provide an inexpensive TTP, which secures a predetermined active area and yet can be downsized.

What is claimed is:

1. A touch panel comprising:
an upper substrate having an upper conductive layer beneath a lower face thereof;
a lower substrate having a lower conductive layer on an upper face thereof;
a adhesive layer for bonding the upper substrate and the lower substrate together at a predetermined spot, the adhesive layer comprising thermoplastic resin and isocyanate hardener and having a width ranging from 0.5 to 2.5 mm.

2. The touch panel of claim 1, wherein at least one of the upper substrate and the lower substrate includes the adhesive layer formed by printing.

3. The touch panel of claim 1, wherein a thickness of the adhesive layer ranges from 5 to 50 μm.

4. The touch panel of claim 1, wherein an modulus of elasticity of the adhesive layer ranges from 10⁴ to 10⁹ Pa at room temperature.

5. The touch panel of claim 1, wherein the isocyanate hardener includes at least two isocyanate groups in one molecule.

6. The touch panel of claim 5, wherein an additive amount of the isocyanate hardener ranges from 1 to 10 in weight vs. an amount of the thermoplastic resin in weight of 100.

7. The touch panel of claim 1, wherein the thermoplastic resin of the adhesive layer is at least one of acrylic resin and polyester resin.

8. The touch panel of claim 1, wherein an average molecular weight of the thermoplastic resin of the adhesive layer is at least 2×10⁵.

9. The touch panel of claim 1, wherein the adhesive layer is shaped like a frame, and corner portions of the adhesive layer are narrower than other portions.

10. The touch panel of claim 1 having a manufacturing method comprising the steps of:
printing the adhesive layer on at least one of the upper substrate and the lower substrate;
placing the upper conductive layer opposite to the lower conductive layer; and
bonding the upper substrate and the lower substrate together by one of heating plus pressing the adhesive layer and only pressing the adhesive layer.
